(19) United States
(12) Patent Application Publication
(10) Pub. No.: US 2022/0020333 A1
(43) Pub. Date: Jan. 20, 2022

(54) DISPLAY DEVICE AND DRIVING METHOD THEREOF

(71) Applicant: SAMSUNG DISPLAY CO., LTD., Yongin-si (KR)

(72) Inventors: Hyun Wook CHO, Yongin-si (KR); Sang Hyun LIM, Yongin-si (KR); Jun Seong LEE, Yongin-si (KR)

(21) Appl. No.: 17/333,804

(22) Filed: May 28, 2021

(30) Foreign Application Priority Data
Jul. 14, 2020 (KR) 10-2020-0086997

(51) Int. Cl. G09G 3/3266

(52) U.S. Cl. CPC G09G 3/3266; G09G 2310/0202

(57) ABSTRACT

A display device includes: a plurality of pixels; a scan driver configured to supply scan signals of a turn-on level to the scan lines at a cycle of a horizontal synchronization signal; a plurality of first sensors and a plurality of second sensors overlapping at least some of the pixels; and a sensor driver configured to concurrently supply first sensing signals to the first sensors during a first sensing period, to concurrently supply second sensing signals to the second sensors during a second sensing period, and to sequentially supply third sensing signals to the first sensors during a third sensing period, wherein the number of the first sensing signals is an integer greater than 2, wherein the first sensing signals are divided into first groups, and wherein an initial first sensing signal in each of the first groups is synchronized with the horizontal synchronization signal.

### CROSS-REFERENCE TO RELATED APPLICATION

The present application claims priority to and the benefit of Korean Patent Application No. 10-2020-0086997, filed Jul. 14, 2020, the entirety of which is incorporated herein by reference for all purposes as if fully set forth herein.

### BACKGROUND

### 1. Field

Aspects of some example embodiments of the present invention relate to a display device and a driving method thereof.

### 2. Discussion

With the development of information technology, the importance of display devices, which provide a connection medium between users and information, has been emphasized. In response to this, the use of display devices such as liquid crystal display devices, organic light emitting display devices, plasma display devices, and the like has been increasing.

Recently, a display device that can be relatively easily and intuitively operated by users touching a graphical representation of an object displayed on a display screen has been widely used. Such a display device may include a sensor unit and a display unit overlapping each other on a plane.

In order to increase portability, the thickness of the display device may have a relatively thin profile.

The above information disclosed in this Background section is only for enhancement of understanding of the background and therefore the information discussed in this Background section does not necessarily constitute prior art.

### SUMMARY

Aspects of some example embodiments may enable reducing the gap between a sensor unit and a display unit and eliminating or reducing electromagnetic interference between the sensor unit and the display unit.

Aspects of some example embodiments may include a display device capable of relatively accurately calculating a touch position of a user, as distinguished from a water droplet or other foreign object, and preventing or reducing display distortion of a display unit, and a driving method thereof.

A display device according to some example embodiments of the present invention may include pixels connected to scan lines; a scan driver supplying scan signals of a turn-on level to the scan lines at a cycle corresponding to a cycle of a horizontal synchronization signal; first sensors and second sensors positioned to overlap at least some of the pixels; and a sensor driver simultaneously supplying first sensing signals to the first sensors during a first sensing period, simultaneously supplying second sensing signals to the second sensors during a second sensing period, and sequentially supplying third sensing signals to the first sensors during a third sensing period. The number of the first sensing signals may be n, where n may be an integer greater than 2, the first sensing signals may be divided into m first groups, where m may be an integer less than n and greater than 1, and an initial first sensing signal in each of the first groups may be synchronized with the horizontal synchronization signal.

According to some example embodiments, each of the first sensing signals may correspond to a rising transition or a falling transition.

According to some example embodiments, the horizontal synchronization signal may include a plurality of pulses, and a time point at which the initial first sensing signal is generated in each of the first groups may be the same as a time point at which one pulse of the horizontal synchronization signal is generated.

According to some example embodiments, a first time interval between the initial first sensing signal and a next first sensing signal in one first group may be different from a second time interval between a last first sensing signal in the one first group and an initial first sensing signal in a next first group.

According to some example embodiments, each of a first frame period and a second frame period following the first frame period may include the first sensing period, the second sensing period, and the third sensing period, and the first sensing signals in the second frame period may be inverted signals of corresponding first sensing signals in the first frame period.

According to some example embodiments, each of the first sensing signals may correspond to a rising transition or a falling transition, and the first sensing signals in the second frame period may have transition directions opposite to the corresponding first sensing signals in the first frame period.

According to some example embodiments, the first sensing signals of the next first group may have the same transition directions as corresponding first sensing signals of the one first group.

According to some example embodiments, the first sensing signals of the next first group may have transition directions opposite to the corresponding first sensing signals of the one first group.

According to some example embodiments, the number of the second sensing signals may be p, where p may be an integer greater than 2, the second sensing signals may be divided into q second groups, where q may be an integer less than p and greater than 1, and an initial second sensing signal in each of the second groups may be synchronized with the horizontal synchronization signal.

According to some example embodiments, a third time interval between the initial second sensing signal and a next second sensing signal in one second group may be different from a fourth time interval between a last second sensing signal in the one second group and an initial second sensing signal in a next second group.

According to some example embodiments, each of the second sensing signals may correspond to a rising transition or a falling transition, and the second sensing signals in the second frame period may have transition directions opposite to corresponding second sensing signals in the first frame period.

According to some example embodiments, the second sensing signals of the next second group may have the same transition directions as corresponding second sensing signals of the one second group.

According to some example embodiments, the second sensing signals of the next second group may have transition directions opposite to the corresponding second sensing signals of the one second group.

According to some example embodiments, the third sensing signals may be synchronized with the horizontal synchronization signal.

According to some example embodiments, each of the third sensing signals may correspond to a rising transition or a falling transition, and the third sensing signals in the second frame period may have transition directions opposite to corresponding third sensing signals in the first frame period.

A driving method of a display device according to some example embodiments of the present invention may include simultaneously supplying first sensing signals to first sensors during a first sensing period of a first frame period;

simultaneously supplying second sensing signals to second sensors during a second sensing period of the first frame period; and sequentially supplying third sensing signals to the first sensors during a third sensing period of the first frame period. The number of the first sensing signals may be n, where n may be an integer greater than 2, the first sensing signals may be divided into m first groups, where m may be an integer less than n and greater than 1, and an initial first sensing signal in each of the first groups may be synchronized with a horizontal synchronization signal.

According to some example embodiments, a first time interval between the initial first sensing signal and a next first sensing signal in one first group may be different from a second time interval between a last first sensing signal in the one first group and an initial first sensing signal in a next first group.

According to some example embodiments, the driving method may further include simultaneously supplying the first sensing signals to the first sensors during the first sensing period in a second frame period following the first frame period; simultaneously supplying the second sensing signals to the second sensors during the second sensing period of the second frame period; and sequentially supplying the third sensing signals to the first sensors during the third sensing period of the second frame period.

According to some example embodiments, each of the first sensing signals may correspond to a rising transition or a falling transition, and the first sensing signals in the second frame period may have transition directions opposite to corresponding first sensing signals in the first frame period.

According to some example embodiments, the first sensing signals of the next first group may have transition directions opposite to corresponding first sensing signals of the one first group.

### BRIEF DESCRIPTION OF THE DRAWINGS

The accompanying drawings, which are included to provide a further understanding of embodiments according to the inventive concepts, and are incorporated in and constitute a part of this specification, illustrate aspects of some example embodiments of the inventive concepts, and, together with the description, serve to explain principles and characteristics of embodiments according to the inventive concepts.

FIG. 1 is a diagram for explaining a display device according to some example embodiments of the present invention.

FIG. 2 is a diagram for explaining a display unit and a display driver according to some example embodiments of the present invention.

FIG. 3 is a diagram for explaining a pixel unit and a data distributer according to some example embodiments of the present invention.

FIG. 4 is a diagram for explaining a pixel according to some example embodiments of the present invention.

FIG. 5 is a diagram for explaining a driving method of the pixel unit and the data distributer according to some example embodiments of the present invention.

FIG. 6 is a diagram for explaining first sensors and second sensors according to some example embodiments of the present invention.

FIGS. 7 and 8 are diagrams for explaining a third sensing period according to some example embodiments of the present invention.

FIGS. 9 to 11 are diagrams for explaining a first sensing period and a second sensing period according to some example embodiments of the present invention.

FIG. 12 is a diagram for explaining a relationship between frame periods and sensing periods according to some example embodiments of the present invention.

FIG. 13 is a diagram for explaining a first sensing period of a first frame period according to some example embodiments of the present invention.

FIG. 14 is a diagram for explaining a first sensing period of a second frame period according to some example embodiments of the present invention.

FIG. 15 is a diagram for explaining a first sensing period of a first frame period according to some example embodiments of the present invention.

FIG. 16 is a diagram for explaining a first sensing period of a second frame period according to some example embodiments of the present invention.

### DETAILED DESCRIPTION

Hereinafter, aspects of some example embodiments of the present invention will be described in more detail with reference to the accompanying drawings so that those skilled in the art may implement the present invention. The present invention may be embodied in various different forms and is not limited to the example embodiments described herein.

In order to more clearly describe the present invention, description of certain elements or components that is not necessary to enable a person having ordinary skill in the art to make and use the invention may be omitted, and the same or similar components are denoted by the same reference numerals throughout the specification. Therefore, the above-mentioned reference numerals can be used in other drawings.

In addition, the size and thickness of each component shown in the drawings are arbitrarily shown for convenience of description, and thus the present invention is not necessarily limited to those shown in the drawings. In the drawings, thicknesses may be exaggerated to clearly express the layers and regions.

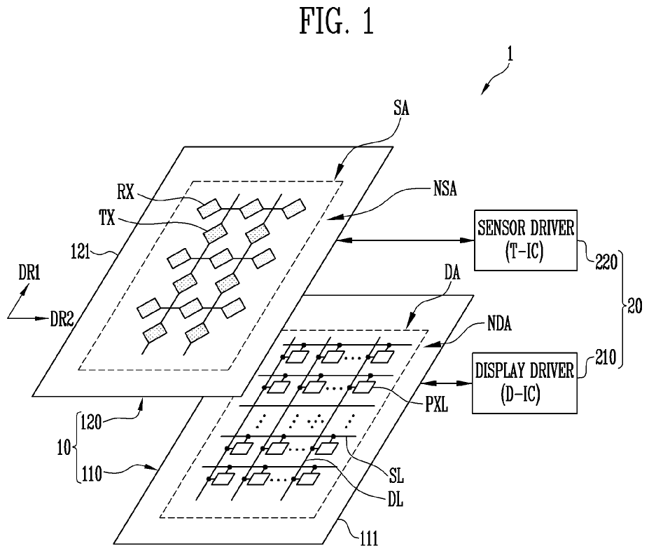

FIG. 1 is a diagram for explaining a display device according to some example embodiments of the present invention.

Referring to FIG. 1, a display device 1 according to some example embodiments of the present invention may include a panel 10 and a driving circuit unit 20 for driving the panel 10.

For example, the panel 10 may include a display unit 110 for displaying images (e.g., static or video images) and a sensor unit 120 for sensing touch, pressure, fingerprints, hovering, and the like. For example, the panel 10 may include pixels PXL and first sensors TX and second sensors RX positioned to overlap at least some of the pixels PXL. The driving circuit unit 20 may include a display driver 210 for driving the display unit 110 and a sensor driver 220 for driving the sensor unit 120.

According to some example embodiments, the display unit 110 and the sensor unit 120 may be manufactured separately from each other and then arranged and/or combined so that at least one area overlaps each other. Alternatively, according to some example embodiments, the display unit 110 and the sensor unit 120 may be integrally manufactured. For example, the sensor unit 120 may be directly formed on at least one substrate constituting the display unit 110 (for example, an upper and/or lower substrate of a display panel, or a thin film encapsulation layer) or on other insulating layers or various functional films (for example, an optical layer or a protective layer).

Meanwhile, in FIG. 1, the sensor unit 120 is shown to be arranged on the front side of the display unit 110 (for example, an upper surface on which the image is displayed), but the position of the sensor unit 120 is not limited thereto. For example, according to some example embodiments, the sensor unit 120 may be arranged on the rear or both sides of the display unit 110. According to some example embodiments, the sensor unit 120 may be arranged on at least one edge area of the display unit 110.

The display unit 110 may include a display substrate 111 and a plurality of pixels PXL formed on the display substrate 111. The pixels PXL may be located in a display area DA of the display substrate 111.

The display substrate 111 may include the display area DA in which an images (e.g., static or video images) are displayed and a non-display area NDA arranged around the display area DA (e.g., outside a footprint of the display area DA or in a periphery of the display area DA). According to some example embodiments, the display area DA may be arranged in a central area of the display unit 110, and the non-display area NDA may be arranged in an edge area of the display unit 110 to surround the display area DA.

The display substrate 111 may be a rigid substrate or a flexible substrate. The material or physical properties of the display substrate 111 are not particularly limited. For example, the display substrate 111 may be the rigid substrate made of glass or tempered glass, or the flexible substrate made of a thin film including plastic or metal.

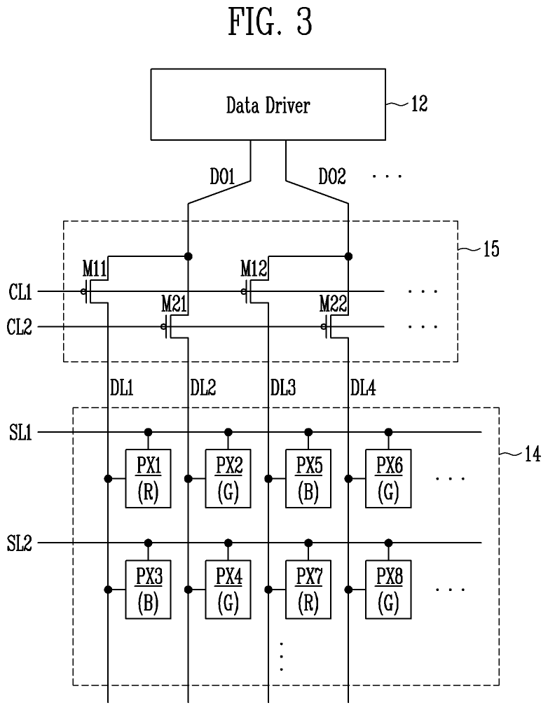

Scan lines SL, data lines DL, and the pixels PXL connected to the scan lines SL and the data lines DL may be arranged in the display area DA. The pixels PXL may be selected by a scan signal of a turn-on level supplied from the scan lines SL to receive a data signal from the data lines DL, and may emit light with a luminance corresponding to the data signal. Accordingly, an image corresponding to the data signal may be displayed in the display area DA. In embodiments according to the present invention, the structure and driving method of the pixels PXL are not particularly limited. For example, each of the pixels PXL may be implemented as a pixel having various known structures and/or driving methods. Hereinafter, a structure and a driving method of example pixels PXL will be described in more detail with reference to FIGS. 3 to 5.

Various wires and/or built-in circuit units connected to the pixels PXL of the display area DA may be located in the non-display area NDA. For example, in the non-display area NDA, a plurality of wirings for supplying various power sources and control signals to the display area DA may be arranged, and a scan driver and the like may be further located in the non-display area NDA.

According to some example embodiments, the type of the display unit 110 is not particularly limited. For example, the display unit 110 may be implemented as a self-emission type display panel such as an organic light emitting display panel. Alternatively, the display unit 110 may be implemented as a non-emission type display panel such as a liquid crystal display panel. When the display unit 110 is implemented as the non-emission type display panel, the display device 1 may further include a light source such as a back light unit.

The sensor unit 120 may include a sensor substrate 121 and a plurality of sensors TX and RX formed on the sensor substrate 121. The sensors TX and RX may be located in a sensing area SA of the sensor substrate 121.

The sensor substrate 121 may include the sensing area SA for sensing a touch input or the like, and a peripheral area NSA surrounding the sensing area SA.

According to some example embodiments, the sensing area SA may be arranged to overlap at least one area of the display area DA. For example, the sensing area SA may be set as an area corresponding to the display area DA (for example, an area overlapping the display area DA), and the peripheral area NSA may be set as an area corresponding to the non-display area NDA (for example, an area overlapping the non-display area NDA). In this case, when the touch input or the like is provided on the display area DA, the touch input may be detected through the sensor unit 120.

The sensor substrate 121 may be a rigid substrate or a flexible substrate. The sensor substrate 121 may be formed of at least one insulating layer. Further, the sensor substrate 121 may be a transparent substrate or a translucent substrate, but embodiments according to the present invention are not limited thereto. That is, in the present invention, the material and physical properties of the sensor substrate 121 are not particularly limited. For example, the sensor substrate 121 may be the rigid substrate made of glass or tempered glass, or the flexible substrate made of a thin film including plastic or metal. In addition, according to some example embodiments, at least one substrate constituting the display unit 110 (for example, the display substrate 111, an encapsulation substrate, and/or the thin film encapsulation layer) or at least one insulating film or functional film located on the inner and/or outer surface of the display unit 110 may be used as the sensor substrate 121.

The sensing area SA may be set as an area capable of responding to the touch input (that is, an active area of a sensor). To this end, the sensors TX and RX for sensing the touch input or the like may be located in the sensing area SA. According to some example embodiments, the sensors TX and RX may include the first sensors TX and the second sensors RX.

For example, each of the first sensors TX may extend in a first direction DR1. The first sensors TX may be arranged in a second direction DR2. The second direction DR2 may be different from the first direction DR1. For example, the second direction DR2 may be a direction orthogonal to the first direction DR1. According to some example embodiments, the extension direction and the arrangement direction of the first sensors TX may have a different configuration. Each of the first sensors TX may have a form in which first cells having a relatively large area and first bridges having a relatively small area are connected to each other. In FIG. 1, each of the first cells is shown in a diamond form, but may be configured in any suitable configuration such as a circle, a square, a triangle, and a mesh. For example, the first bridges may be integrally formed on the same layer as the first cells. According to some example embodiments, the first bridges may be formed on a layer different from the first cells to electrically connect adjacent first cells.

For example, each of the second sensors RX may extend in the second direction DR2. The second sensors RX may be arranged in the first direction DR1. According to some example embodiments, the extension direction and the arrangement direction of the second sensors RX may follow another configuration. Each of the second sensors RX may have a form in which second cells having a relatively large area and second bridges having a relatively small area are connected to each other. In FIG. 1, each of the second cells is shown in a diamond form, but may be configured in any suitable configuration such as a circle, a square, a triangle, and a mesh. For example, the second bridges may be integrally formed on the same layer as the second cells. According to some example embodiments, the second bridges may be formed on a layer different from the second cells to electrically connect adjacent second cells.

According to some example embodiments, each of the first sensors TX and the second sensors RX may have conductivity by including at least one of a metal material, a transparent conductive material, or various other conductive materials. For example, the first sensors TX and the second sensors RX may include at least one of various metal materials including gold (Au), silver (Ag), aluminum (Al), molybdenum (Mo), chromium (Cr), titanium (Ti), nickel (Ni), neodymium (Nd), copper (Cu), platinum (Pt), or an alloy thereof. In this case, the first sensors TX and the second sensors RX may have a mesh form. In addition, the first sensors TX and the second sensors RX may include at least one of various transparent conductive materials including silver nanowires (AgNW), ITO (Indium Tin Oxide), IZO (Indium Zinc Oxide), IGZO (Indium Gallium Zinc Oxide), AZO (Antimony Zinc Oxide), ITZO (Indium Tin Zinc Oxide), ZnO (Zinc Oxide), SnO₂ (Tin Oxide), carbon nanotubes, graphene, and the like. In addition, the first sensors TX and the second sensors RX may have conductivity by including at least one of various conductive materials. In addition, each of the first sensors TX and the second sensors RX may be formed of a single layer or multiple layers, and a cross-sectional structure thereof is not particularly limited.

Meanwhile, in the peripheral area NSA of the sensor unit 120, sensor lines for electrically connecting the sensors TX and RX to the sensor driver 220 or the like may be arranged.

The driving circuit unit 20 may include the display driver 210 for driving the display unit 110 and the sensor driver 220 for driving the sensor unit 120. According to some example embodiments, the display driver 210 and the sensor driver 220 may be configured of separate ICs (integrated circuits). According to some example embodiments, at least a portion of the display driver 210 and the sensor driver 220 may be integrated together in one IC.

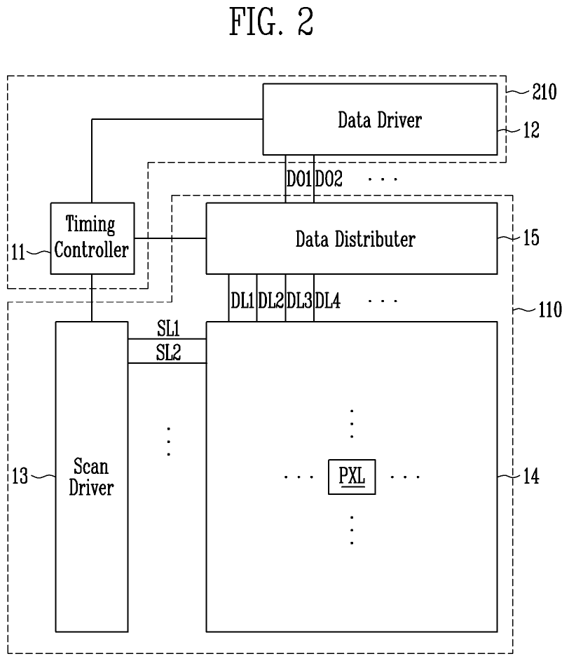

The display driver 210 may be electrically connected to the display unit 110 to drive the pixels PXL. For example, the display driver 210 may include a data driver 12 and a timing controller 11, and a scan driver 13 and a data distributer 15 may be separately mounted in the non-display area NDA of the display unit 110 (refer to FIG. 2). According to some example embodiments, the display driver 210 may include all or at least a portion of the data driver 12, the timing controller 11, the scan driver 13, and the data distributer 15.

The sensor driver 220 may be electrically connected to the sensor unit 120 to drive the sensor unit 120. The sensor driver 220 may include a sensor transmitter and a sensor receiver. According to some example embodiments, the sensor transmitter and the sensor receiver may be integrated into one IC, but embodiments according to the present invention are not limited thereto.

FIG. 2 is a diagram for explaining a display unit and a display driver according to some example embodiments of the present invention.

Referring to FIG. 2, the display driver 210 may include the data driver 12 and the timing controller 11, and the display unit 110 may include the scan driver 13 and the data distributer 15. However, as described above, whether the functional units are to be integrated into one IC, a plurality of ICs, or mounted on the display substrate 111 may be variously selected according to the specifications of the display device 1.

The timing controller 11 may receive grayscale values and control signals for each frame from an external processor. The control signals may include a vertical synchronization signal, a horizontal synchronization signal, and a data enable signal. The vertical synchronization signal may include a plurality of pulses. Based on a time point at which each pulse occurs, the end of a previous frame period and the start of a current frame period may be indicated. An interval between adjacent pulses of the vertical synchronization signal may correspond to one frame period. The horizontal synchronization signal may include a plurality of pulses. Based on a time point at which each pulse occurs, the end of a previous horizontal period and the start of a new horizontal period may be indicated. An interval between adjacent pulses of the horizontal synchronization signal may correspond to one horizontal period. The data enable signal may indicate that RGB data is supplied in a horizontal period.

The timing controller 11 may render the grayscale values to correspond to the specifications of the display device 1. For example, the external processor may provide a red grayscale value, a green grayscale value, and a blue grayscale value for each unit dot. For example, when the pixel unit 14 has an RGB stripe structure, the pixels may correspond to each grayscale value on a one-to-one basis. In this case, rendering of the grayscale values may not be required. However, for example, when the pixel unit 14 has a pentile structure, because adjacent unit dots share pixels, the pixels may not correspond to each grayscale value on a one-to-one basis. In this case, rendering of the grayscale values may be required. The grayscale values that are rendered or not rendered may be provided to the data driver 12. In addition, the timing controller 11 may provide a data control signal to the data driver 12. Also, the timing controller 11 may provide a scan control signal to the scan driver 13.

The data driver 12 may generate data signals to be provided to data output lines DO1 and DO2 using the grayscale values and the data control signal received from the timing controller 11. For example, the data driver 12 may provide first data signals to the data output lines DO1 and DO2 during a first period. The data driver 12 may provide second data signals to the data output lines DO1 and DO2 during a second period after the first period. The data driver 12 may provide third data signals to the data output lines DO1 and DO2 during a third period after the second period. The data driver 12 may provide fourth data signals to the data output lines DO1 and DO2 during a fourth period after the third period.

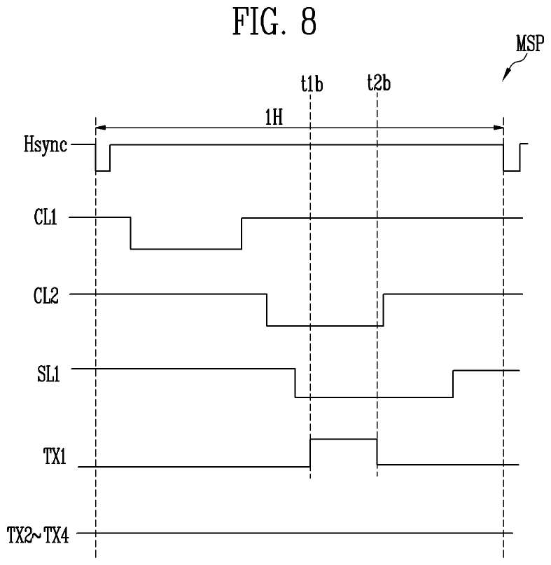

The scan driver 13 may generate scan signals to be provided to scan lines SL1 and SL2 using a clock signal, a scan start signal and the like received from the timing controller 11. The scan driver 13 may sequentially supply the scan signals having a turn-on level pulse to the scan lines SL1 and SL2. For example, the scan driver 13 may supply the scan signals of the turn-on level to the scan lines at a cycle corresponding to a cycle of the horizontal synchronization signal (refer to FIG. 8). The scan driver 13 may include scan stages configured in the form of a shift register. The scan driver 13 may generate the scan signals by sequentially transferring the scan start signal in the form of a turn-on level pulse to a next scan stage under the control of the clock signal.

The pixel unit 14 may include the pixels PXL. Each of the pixels PXL may be connected to a corresponding data line and a corresponding scan line. The pixels PXL may include pixels emitting light of a first color, pixels emitting light of a second color, and pixels emitting light of a third color. The first color, the second color, and the third color may be different colors. For example, the first color may be one of red, green, and blue, the second color may be one of red, green, and blue other than the first color, and the third color may be one of red, green, and blue other than the first and second colors. In addition, magenta, cyan, and yellow may be used instead of red, green, and blue as the first to third colors. However, in the present embodiment, for convenience of description, red, green, and blue are used as the first to third colors. Also, magenta may be expressed by a combination of red and blue, cyan may be expressed by a combination of green and blue, and yellow may be expressed by a combination of red and green.

The data distributer 15 may selectively connect the data output lines DO1 and DO2 and data lines DL1, DL2, DL3, and DL4. The number of data lines DL1 to DL4 may be greater than the number of data output lines DO1 and DO2. For example, the number of data lines DL1 to DL4 may correspond to an integer multiple of the number of data output lines DO1 and DO2. The data distributer 15 may be a kind of demultiplexer.

For example, a ratio of the data output lines DO1 and DO2 and the data lines DL1 to DL4 may be 1:2. For example, the data distributer 15 may alternately connect the data output lines DO1 and DO2 to odd-numbered data lines or even-numbered data lines. For example, the data distributer 15 may connect the data output lines DO1 and DO2 to first data lines DL1 and DL3 during the first period. The data distributer 15 may connect the data output lines DO1 and DO2 to second data lines DL2 and DL4 during the second period. The data distributer 15 may connect the data output lines DO1 and DO2 to the first data lines DL1 and DL3 during the third period. The data distributer 15 may connect the data output lines DO1 and DO2 to the second data lines DL2 and DL4 during the fourth period.

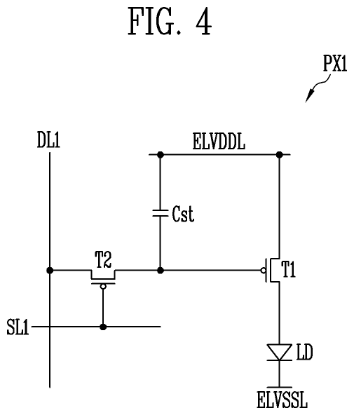

FIG. 3 is a diagram for explaining a pixel unit and a data distributer according to some example embodiments of the present invention. FIG. 4 is a diagram for explaining a pixel according to some example embodiments of the present invention.

Referring to FIG. 3, the data distributer 15 may include first transistors M11 and M12 and second transistors M21 and M22. Gate electrodes of the first transistors M11 and M12 may be connected to a first control line CL1, first electrodes of the first transistors M11 and M12 may be connected to the data output lines DO1 and DO2, and second electrodes of the first transistors M11 and M12 may be connected to the first data lines DL1 and DL3. Gate electrodes of the second transistors M21 and M22 may be connected to a second control line CL2, first electrodes of the second transistors M21 and M22 may be connected to the data output lines DO1 and DO2, and second electrodes of the second transistors M21 and M22 may be connected to the second data lines DL2 and DL4. For example, the data distributer 15 may be a demultiplexer having an input and output ratio of 1:2.

A turn-on period of the first transistors M11 and M12 and a turn-on period of the second transistors M21 and M22 may not overlap each other. The timing controller 11 may provide control signals of a turn-on level to the first and second control lines CL1 and CL2 so that the first transistors M11 and M12 and the second transistors M21 and M22 are alternately turned on.

For example, the number of first transistors M11 and M12 and the number of second transistors M21 and M22 may be the same. Also, the number of first data lines DL1 and DL3 and the number of second data lines DL2 and DL4 may be the same. The first data lines DL1 and DL3 and the second data lines DL2 and DL4 may be arranged to alternate with each other.

For example, the pixel unit 14 may include pixels PX1, PX2, PX3, PX4, PX5, PX6, PX7, and PX8 arranged in the pentile structure. First pixels PX1, PX2, PX5, and PX6 may be connected to a first scan line SL1. The first pixels PX1, PX2, PX5, and PX6 may be repeatedly arranged in the order of red, green, blue, and green along a direction in which the first scan line SL1 is extended. The first pixels PX1, PX2, PX5, and PX6 may be connected to the data lines DL1, DL2, DL3, and DL4, respectively.

In addition, second pixels PX3, PX4, PX7, and PX8 may be connected to a second scan line SL2. The second pixels PX3, PX4, PX7, and PX8 may be repeatedly arranged in the order of blue, green, red, and green along a direction in which the second scan line SL2 is extended. The second pixels PX3, PX4, PX7, and PX8 may be connected to the data lines DL1, DL2, DL3, and DL4, respectively.

Red pixels and blue pixels may be repeatedly connected to a first data line DL1 along a direction in which the first data line DL1 is extended. Green pixels may be connected to second and fourth data lines DL2 and DL4 along a direction in which the second and fourth data lines DL2 and DL4 are extended. The blue pixels and the red pixels may be repeatedly connected to a third data line DL3 along a direction in which the third data line DL3 is extended.

Referring to FIG. 4, an example first pixel PX1 is shown. Because the other pixels PX2 to PX8 may also have substantially the same configuration, some duplicate descriptions may be omitted.

A gate electrode of a transistor T1 may be connected to a second electrode of a storage capacitor Cst, a first electrode of the transistor T1 may be connected to a first power source line ELVDDL, and a second electrode of the transistor T1 may be connected to an anode of a light emitting diode LD. The transistor T1 may be referred to as a driving transistor.

A gate electrode of a transistor T2 may be connected to the first scan line SL1, a first electrode of the transistor T2 may be connected to the first data line DL1, and a second electrode of the transistor T2 may be connected to the second electrode of the storage capacitor Cst. The transistor T2 may be referred to as a scan transistor.

A first electrode of the storage capacitor Cst may be connected to the first power source line ELVDDL, and the second electrode of the storage capacitor Cst may be connected to the gate electrode of the transistor T1.

The anode of the light emitting diode LD may be connected to the second electrode of the transistor T1 and a cathode of the light emitting diode LD may be connected to a second power source line ELVSSL. During an emission period of the light emitting diode LD, a first power source voltage applied to the first power source line ELVDDL may be greater than a second power source voltage applied to the second power source line ELVSSL.

Here, the transistors T1, T2, M11, M12, M21, and M22 are shown as P-type transistors, but those skilled in the art may replace at least one of the transistors with an N-type transistor by inverting the phase of a signal.

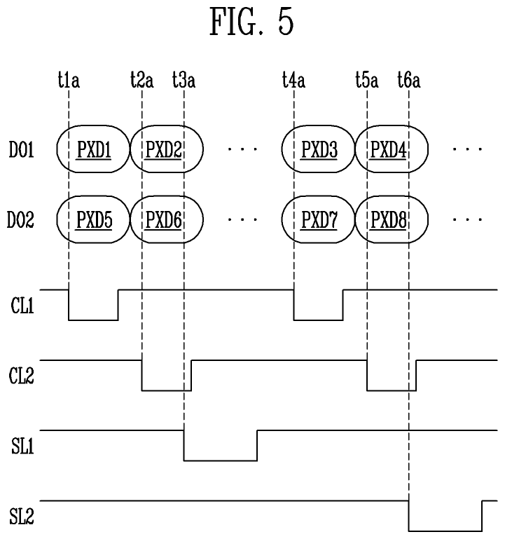

FIG. 5 is a diagram for explaining a driving method of the pixel unit and the data distributer according to some example embodiments of the present invention.

First, at a time point t1a, a first control signal of a turn-on level (low level) may be applied to the first control line CL1. Accordingly, the first transistors M11 and M12 may be turned on, a first data output line DO1 and the first data line DL1 may be connected, and a second data output line DO2 and a first data line DL3 may be connected. At this time, the data driver 12 may output a first data signal PXD1 to the first data output line DO1 and may output a first data signal PXDS to the second data output line DO2. Accordingly, the first data line DL1 may be charged with the first data signal PXD1, and the first data line DL3 may be charged with the first data signal PXDS. A period from the time point t1a to a time point at which the first control signal of a turn-off level is applied may be referred to as the first period.

Next, at a time point t2a, a second control signal of the turn-on level may be applied to the second control line CL2. Accordingly, the second transistors M21 and M22 may be turned on, the first data output line DO1 and a second data line DL2 may be connected, and the second data output line DO2 and a second data line DL4 may be connected. At this time, the second data line DL2 may be charged with a second data signal PXD2, and the second data line DL4 may be charged with a second data signal PXD6. A period from the time point t2a to a time point at which the second control signal of the turn-off level is applied may be referred to as the second period.

Next, at a time point t3a, a first scan signal of a turn-on level may be applied to the first scan line SL1. Accordingly, the first pixels PX1, PX2, PX5, and PX6 may receive data signals charged in the first data lines DL1 and DL3 and the second data lines DL2 and DL4. According to some example embodiments, the time point t3a may be positioned during the second period.

Next, at a time point t4a, the first control signal of the turn-on level may be applied to the first control line CL1. Accordingly, the first transistors M11 and M12 may be turned on, the first data output line DO1 and the first data line DL1 may be connected, and the second data output line DO2 and the first data line DL3 may be connected. At this time, the first data line DL1 may be charged with a third data signal PXD3, and the first data line DL3 may be charged with a third data signal PXD7. A period from the time point t4a to a time point at which the first control signal of the turn-off level is applied may be referred to as the third period.

Next, at a time point t5a, the second control signal of the turn-on level may be applied to the second control line CL2. Accordingly, the second transistors M21 and M22 may be turned on, the first data output line DO1 and the second data line DL2 may be connected, and the second data output line DO2 and the second data line DL4 may be connected. At this time, the second data line DL2 may be charged with a fourth data signal PXD4, and the second data line DL4 may be charged with a fourth data signal PXD8. A period from the time point t5a to a time point at which the second control signal of the turn-off level is applied may be referred to as the fourth period.

Next, at a time point t6a, a second scan signal of the turn-on level may be applied to the second scan line SL2. Accordingly, the second pixels PX3, PX4, PX7, and PX8 may receive the data signals charged in the first data lines DL1 and DL3 and the second data lines DL2 and DL4. According to some example embodiments, the time point t6a may be positioned during the fourth period.

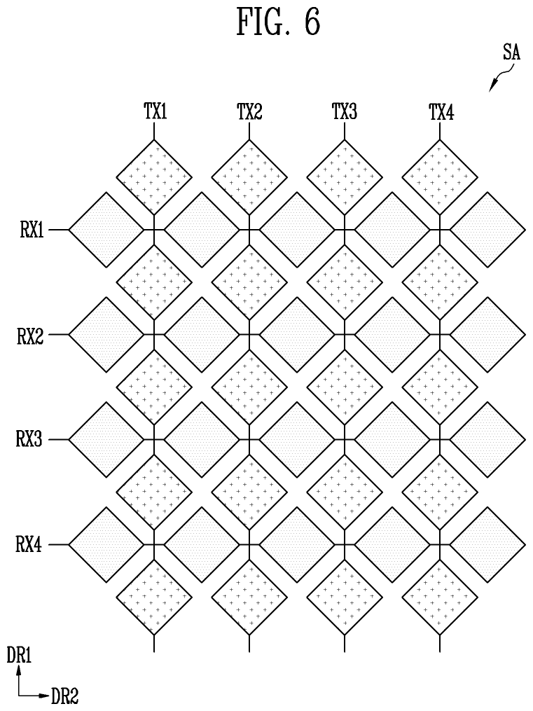

FIG. 6 is a diagram for explaining first sensors and second sensors according to some example embodiments of the present invention.

Referring to FIG. 6, first sensors TX1, TX2, TX3, and TX4 and second sensors RX1, RX2, RX3, and RX4 positioned in the sensing area SA are shown by way of example. For convenience of explanation, a case in which four first sensors TX1 to TX4 and four second sensors RX1 to RX4 are arranged in the sensing area SA will be described in more detail. Embodiments according to the present disclosure are not limited thereto, however, and some example embodiments may include a different number of first sensors and second sensors (e.g., more or fewer) without departing from the spirit and scope of embodiments according to the present disclosure.

Because descriptions of the first sensors TX1 to TX4 and the second sensors RX1 to RX4 are the same as those of the first sensors TX and the second sensors RX of FIG. 1, some duplicate descriptions thereof may be omitted.

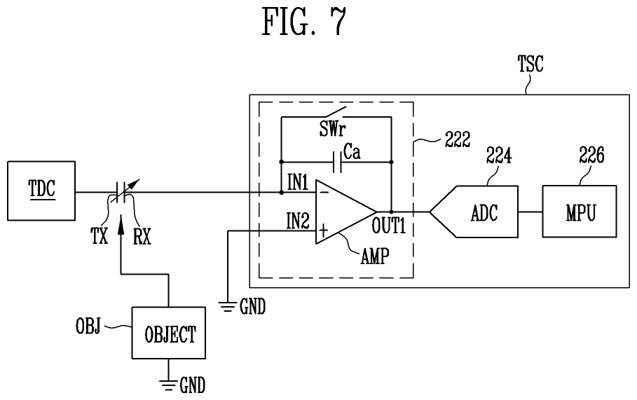

FIGS. 7 and 8 are diagrams for explaining a third sensing period according to some example embodiments of the present invention.

A third sensing period MSP may be a period in which the sensor unit 120 and the sensor driver 220 are driven in a mutual capacitance mode. In FIG. 7, configurations of the sensor unit 120 and the sensor driver 220 are shown based on any one sensor channel 222.

The sensor driver 220 may include a sensor receiver TSC and a sensor transmitter TDC. In the third sensing period MSP, the sensor transmitter TDC may be connected to the first sensors TX, and the sensor receiver TSC may be connected to the second sensors RX.

The sensor receiver TSC may include an operational amplifier AMP, an analog-to-digital converter 224, and a processor 226. For example, each sensor channel 222 may be implemented as an analog front end (AFE) including at least one operational amplifier AMP. The analog-to-digital converter 224 and the processor 226 may be provided for each sensor channel 222, or may be shared by a plurality of sensor channels 222.

A first input terminal IN1 of the operational amplifier AMP may be connected to a corresponding second sensor, and a second input terminal IN2 of the operational amplifier AMP may be connected to a reference power source GND. For example, the first input terminal IN1 may be an inverting terminal, and the second input terminal IN2 may be a non-inverting terminal. The reference power source GND may be a ground voltage or a voltage having a specific level.

The analog-to-digital converter 224 may be connected to an output terminal OUT1 of the operational amplifier AMP. A capacitor Ca and a switch SWr may be connected in parallel between the first input terminal IN1 and the output terminal OUT1.

During the third sensing period MSP, the sensor driver 220 (for example, the sensor transmitter TDC) may sequentially supply third sensing signals to the first sensors TX1 to TX4. For example, the sensor driver 220 may supply a third sensing signal to a first sensor TX1 at least once during one horizontal period 1H, and may supply the third sensing signal to a first sensor TX2 at least once during a next horizontal period 1H.

The third sensing signals may be synchronized with a horizontal synchronization signal Hsync. A cycle in which the third sensing signals are supplied to each of the first sensors TX1 and TX2 may be the same as one horizontal period 1H. That is, the third sensing signals may include the same frequency component as the frequency of the horizontal synchronization signal Hsync. The number of third sensing signals supplied to each of the first sensors TX1 and TX2 may be the same.

Referring to FIG. 8, an example in which the sensor driver 220 supplies the third sensing signals to the first sensor TX1 twice at time points t1b and t2b during one horizontal period 1H is shown. In this case, the third sensing signals may not be supplied to the other first sensors TX2 to TX4 during the horizontal period 1H.

Each of the third sensing signals may correspond to a rising transition or a falling transition. For example, the third sensing signal at the time point t1b may correspond to the rising transition. That is, at the time point t1b, the third sensing signal may rise from a low level to a high level. The third sensing signal at the time point t2b may correspond to the falling transition. That is, at the time point t2b, the third sensing signal may fall from the high level to the low level.

The time points t1b and t2b at which the third sensing signals are supplied may be included in a period in which the second control signal of the turn-on level is applied to the second control line CL2. During this period, because voltages of the pixel unit 14 (for example, voltages of the data lines DL1 to DL4) are supported by the data driver 12 (not in a floating state), even if the third sensing signals are generated, there is low possibility of distortion in the data signals.

The sensor receiver TSC may include a plurality of sensor channels 222 connected to the plurality of second sensors RX. Each of the sensor channels 222 may receive third sampling signals corresponding to third sensing signals from a corresponding second sensor. For example, in response to the third sensing signal applied to the first sensor TX1 at the time point t1b, the sensor channels 222 connected to the second sensors RX1 to RX4 may independently receive the third sampling signals. In addition, in response to the third sensing signal applied to the first sensor TX1 at the time point t2b, the sensor channels 222 connected to the second sensors RX1 to RX4 may independently receive the third sampling signals.

In the sensing area SA, mutual capacitance between the first sensors TX1 to TX4 and the second sensors RX1 to RX4 may be changed according to the position of an object OBJ such as a user's finger. Accordingly, the third sampling signals received by the sensor channels 222 may also be different from each other. The touch position of the object OBJ may be detected by using a difference between the third sampling signals.

The sensor channel 222 may generate an output signal corresponding to a voltage difference between the first and second input terminals IN1 and IN2. For example, the sensor channel 222 may amplify the voltage difference between the first and second input terminals IN1 and IN2 to a degree corresponding to a gain (e.g., a set or predetermined gain), and output the amplified voltage.

According to some example embodiments, the sensor channel 222 may be implemented as an integrator. In this case, the capacitor Ca and the switch SWr may be connected in parallel between the first input terminal IN1 and the output terminal OUT1 of the operational amplifier AMP. For example, when the switch SWr is turned on before a third sampling signal is received, charges in the capacitor Ca may be initialized. At a time point at which the third sampling signal is received, the switch SWr may be in a turned-off state.

The analog-to-digital converter 224 may convert an analog signal input from each of the sensor channels 222 into a digital signal. The processor 226 may analyze the digital signal to detect a user's input.

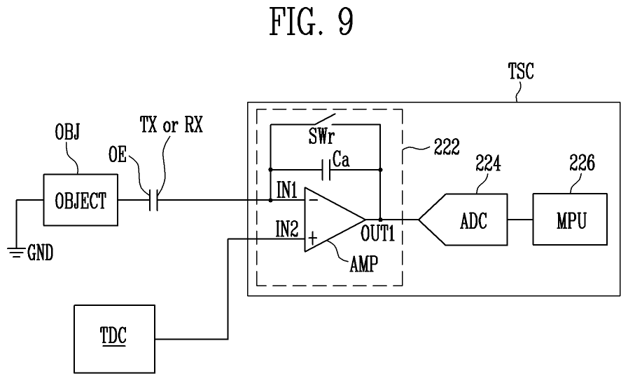

FIGS. 9 to 11 are diagrams for explaining a first sensing period and a second sensing period according to some example embodiments of the present invention.

In FIG. 9, configurations of the sensor unit 120 and the sensor driver 220 are shown based on any one sensor channel 222. Configurations of the sensor receiver TSC and the sensor transmitter TDC may be substantially the same as the configurations of the embodiment of FIG. 7. Therefore, some duplicate descriptions thereof may be omitted, and differences will be mainly described below.

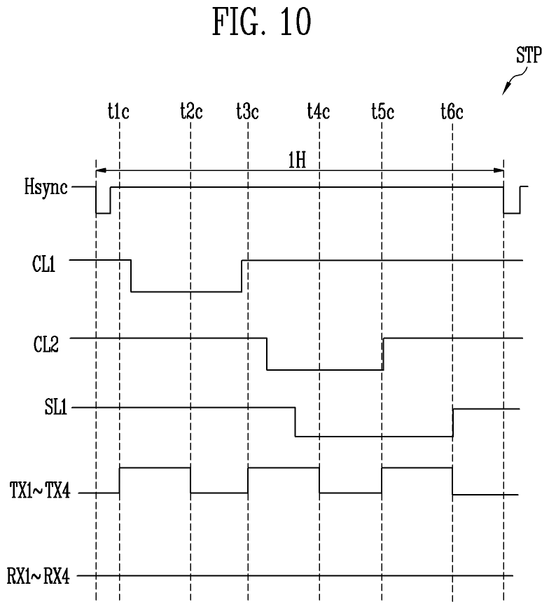

Referring to FIG. 10, a first sensing period STP may be a period in which the sensor unit 120 and the sensor driver 220 are driven in a self-capacitance mode. In the first sensing period STP, the sensor transmitter TDC may be connected to the second input terminal IN2 of each sensor channel 222, and a corresponding first sensor may be connected to the first input terminal IN1 of each sensor channel 222.

For example, during the first sensing period STP, the sensor transmitter TDC may supply a first sensing signal to the second input terminal IN2 of each sensor channel 222. In this case, the first sensing signal may be supplied to the first sensor connected to the first input terminal IN1 according to the characteristics of the operational amplifier AMP. According to some example embodiments, the sensor driver 220 may simultaneously (or concurrently) supply first sensing signals to the first sensors TX1 to TX4 during the first sensing period STP. For example, referring to FIG. 10, the first sensing signals may be simultaneously (or concurrently) supplied to the first sensors TX1 to TX4 at each time point t1c, t2c, t3c, t4c, t5c, and t6c within one horizontal period 1H. At this time, a separate reference voltage may be applied to the second sensors RX1 to RX4, or the second sensors RX1 to RX4 may be in a floating state.

For example, the sensor driver 220 may supply the first sensing signals at a frequency different from the frequency of the horizontal synchronization signal Hsync. Accordingly, as the first sensing signals are supplied at a frequency different from the frequency of the third sensing signals, the sensor driver 220 may be robust against touch malfunction caused by external noise of the same frequency.

Each of the first sensing signals may correspond to the rising transition or the falling transition. For example, the first sensing signals at the time points t1c, t3c, and t5c may correspond to the rising transition. That is, at the time points t1c, t3c, and t5c, the first sensing signals may rise from the low level to the high level. The first sensing signals at the time points t2c, t4c, and t6c may correspond to the falling transition. That is, at the time points t2c, t4c, and t6c, the first sensing signals may fall from the high level to the low level.

The first sensors TX1 to TX4 may have self-capacitance. In this case, when the object OBJ such as the user's finger is close to the first sensors TX1 to TX4, the self-capacitance of the first sensors TX1 to TX4 may be changed according to a surface OE of the object OBJ and the formed capacitance. The first sensing signal reflecting such self-capacitance may be referred to as a first sampling signal. The touch position of the object OBJ in the second direction DR2 may be detected by using the difference between first sampling signals for the first sensors TX1 to TX4.

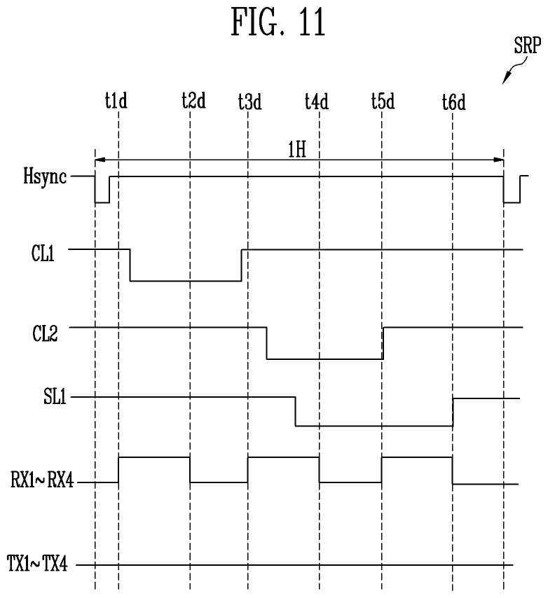

Referring to FIG. 11, a second sensing period SRP may be a period in which the sensor unit 120 and the sensor driver 220 are driven in the self-capacitance mode. In the second sensing period SRP, the sensor transmitter TDC may be connected to the second input terminal IN2 of each sensor channel 222, and a corresponding second sensor may be connected to the first input terminal IN1 of each sensor channel 222.

For example, during the second sensing period SRP, the sensor transmitter TDC may supply a second sensing signal to the second input terminal IN2 of each sensor channel 222. In this case, the second sensing signal may be supplied to the second sensor connected to the first input terminal IN1 according to the characteristics of the operational amplifier AMP. According to some example embodiments, the sensor driver 220 may simultaneously (or concurrently) supply second sensing signals to the second sensors RX1 to RX4 during the second sensing period SRP. For example, referring to FIG. 11, the second sensing signals may be simultaneously (or concurrently) supplied to the second sensors RX1 to RX4 at each time point t1d, t2d, t3d, t4d, t5d, and t6d within one horizontal period 1H. At this time, a separate reference voltage may be applied to the first sensors TX1 to TX4, or the first sensors TX1 to TX4 may be in a floating state.

For example, the sensor driver 220 may supply the second sensing signals at a frequency different from the frequency of the horizontal synchronization signal Hsync. Accordingly, as the second sensing signals are supplied at a frequency different from the frequency of the third sensing signals, the sensor driver 220 may be robust against the touch malfunction caused by the external noise of the same frequency.

Each of the second sensing signals may correspond to the rising transition or the falling transition. For example, the second sensing signals at the time points t1d, t3d, and t5d may correspond to the rising transition. That is, at the time points t1d, t3d, and t5d, the second sensing signals may rise from the low level to the high level. The second sensing signals at the time points t2d, t4d, and t6d may correspond to the falling transition. That is, at the time points t2d, t4d, and t6d, the second sensing signals may fall from the high level to the low level.

The second sensors RX1 to RX4 may have the self-capacitance. In this case, when the object OBJ such as the user's finger is close to the second sensors RX1 to RX4, the self-capacitance of the second sensors RX1 to RX4 may be changed according to the surface OE of the object OBJ and the formed capacitance. The second sensing signal reflecting such self-capacitance may be referred to as a second sampling signal. The touch position of the object OBJ in the first direction DR1 may be detected by using the difference between second sampling signals for the second sensors RX1 to RX4.

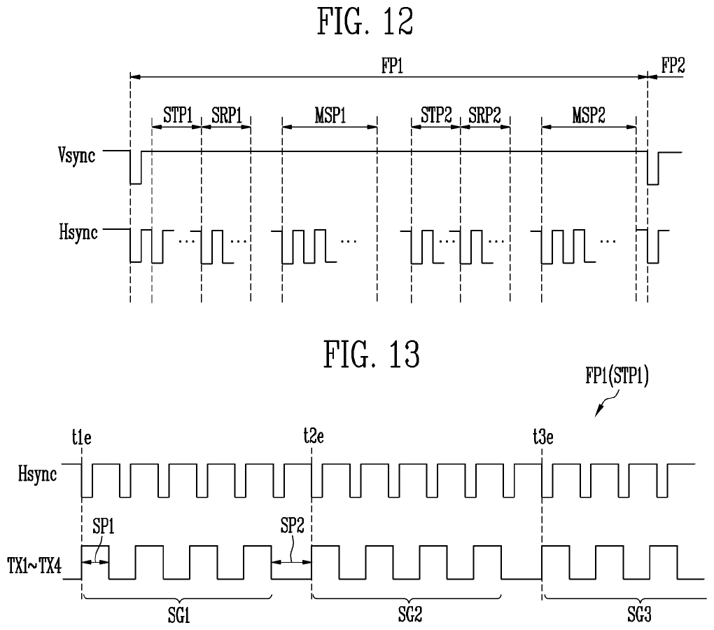

FIG. 12 is a diagram for explaining a relationship between frame periods and sensing periods according to some example embodiments of the present invention.

Referring to FIG. 12, a first frame period FP1 may include first sensing periods STP1 and STP2, second sensing periods SRP1 and SRP2, and third sensing periods MSP1 and MSP2. A second frame period FP2 following the first frame period FP1 may include first sensing periods, second sensing periods, and third sensing periods like the first frame period FP1. Each of the first and second frame periods FP1 and FP2 may correspond to a cycle of pulses of a vertical synchronization signal Vsync.

The first frame period FP1 may include at least one first sensing period STP1, at least one second sensing period SRP1, and at least one third sensing period MSP1.

A case where a water droplet fall on a part of the sensing area SA and a user's touch is made to another part of the sensing area SA will be described as an example. During a third sensing period MSP1, the position of the water droplet and the touch position may be precisely sensed, but it may be difficult to distinguish between the water droplet and the touch.

To compensate for this, a first sensing period STP1 and a second sensing period SRP1 may be provided. By combining the touch position of the object OBJ detected with respect to the second direction DR2 during the first sensing period STP1 and the touch position of the object OBJ detected with respect to the first direction DR1 during the second sensing period SRP1, the touch position of the user may be approximately sensed. In the first sensing period STP1 and the second sensing period SRP1, the position of the water droplet may not be sensed.

Accordingly, when the first and second sensing periods STP1 and SRP1 are provided, the touch position of the user can be accurately calculated by excluding the sensing result by the water droplet in the third sensing period MSP1.

In a first sensing period STP2, a second sensing period SRP2, and a third sensing period MSP2, the sensor driver 220 may be driven in the same manner as the first sensing period STP1, the second sensing period SRP1, and the third sensing period MSP1. Therefore, some duplicate descriptions thereof may be omitted.

FIG. 13 is a diagram for explaining a first sensing period of a first frame period according to some example embodiments of the present invention.

The number of first sensing signals is n, and n may be an integer greater than 2. In this case, the first sensing signals may be divided into m first groups SG1, SG2, and SG3, and m may be an integer less than n and greater than 1. For example, referring to FIG. 13, each of the first groups SG1, SG2, and SG3 may include eight first sensing signals.

According to some example embodiments, an initial first sensing signal in each of the first groups SG1, SG2, and SG3 may be synchronized with the horizontal synchronization signal Hsync. The horizontal synchronization signal Hsync may include a plurality of pulses. For example, the initial first sensing signal (the rising transition) in a first group SG1 may be synchronized with the horizontal synchronization signal Hsync at a time point t1e. For example, the time point t1e at which the initial first sensing signal (the rising transition) in the first group SG1 is generated may be the same as the time point t1e at which one pulse of the horizontal synchronization signal Hsync is generated. For example, the initial first sensing signal (the rising transition) in a first group SG2 may be synchronized with the horizontal synchronization signal Hsync at a time point t2e. For example, the time point t2e at which the initial first sensing signal (the rising transition) in the first group SG2 is generated may be the same as the time point t2e at which one pulse of the horizontal synchronization signal Hsync is generated. For example, the initial first sensing signal (the rising transition) in a first group SG3 may be synchronized with the horizontal synchronization signal Hsync at a time point t3e. For example, the time point t3e at which the initial first sensing signal (the rising transition) in the first group SG3 is generated may be the same as the time point t3e at which one pulse of the horizontal synchronization signal Hsync is generated.

A first time interval SP1 between the initial first sensing signal (the rising transition) and a next first sensing signal (the falling transition) in one first group SG1 may be different from a second time interval SP2 between a last first sensing signal (the falling transition) in one first group SG1 and the initial first sensing signal (the rising transition) in a next first group SG2. For example, except for the second time interval SP2, time intervals between adjacent first sensing signals in one first group SG1 may be the same as the first time interval SP1.

That is, according to some example embodiments, the first sensing signals may be synchronized with the horizontal synchronization signal Hsync in units of groups. In other words, according to some example embodiments, the first sensing signals may be partially synchronized with the horizontal synchronization signal Hsync. According to some example embodiments, because the first sensing signals are not completely synchronized with the horizontal synchronization signal Hsync, a risk due to the external noise of the same frequency described above can be avoided. In addition, because the first sensing signals are not completely unsynchronized with the horizontal synchronization signal Hsync, display distortion of the display unit 110 may be minimized. For reference, when the first sensing signals are completely unsynchronized with the horizontal synchronization signal Hsync, a (undesired) flowing horizontal stripe may be displayed on the display unit 110.

According to some example embodiments, the first sensing signals of the next first group SG2 may have the same transition directions as the corresponding first sensing signals of one first group SG1. For example, referring to FIG. 13, the eight first sensing signals of each of the first groups SG1, SG2, and SG3 may alternately repeat the rising transition and the falling transition, but a first transition may be the rising transition and a last transition may be the falling transition. That is, in the embodiment of FIG. 13, inversion did not occur in units of groups.

FIG. 14 is a diagram for explaining a first sensing period of a second frame period according to some example embodiments of the present invention.

As described above, the second frame period FP2 may include at least one first sensing period STP1, at least one second sensing period, and at least one third sensing period. Hereinafter, a difference between the second frame period FP2 and the first frame period FP1 will be mainly described, and some duplicate descriptions may be omitted.

The first sensing signals in the second frame period FP2 may be inverted signals of the corresponding first sensing signals in the first frame period FP1. For example, the first sensing signals in the second frame period FP2 may have transition directions opposite to the corresponding first sensing signals in the first frame period FP1.

For example, an initial first group SG4 in the first sensing period STP1 of the second frame period FP2 may correspond to an initial first group SG1 in the first sensing period STP1 of the first frame period FP1. As described above, the first sensing signals of the first group SG1 in the first frame period FP1 may alternately repeat the rising transition and the falling transition, but the first transition may be the rising transition and the last transition may be the falling transition. Accordingly, the first sensing signals of the first group SG4 in the second frame period FP2 may alternately repeat the falling transition and the rising transition, but the first transition may be the falling transition and the last transition may be the rising transition. Time intervals between transitions of the first group SG1 and the first group SG4 may be the same. For example, the first time interval SP1 and a first time interval SP3 may be the same, and the second time interval SP2 and a second time interval SP4 may be the same.

Remaining first groups SG5 and SG6 of the second frame period FP2 may correspond to the first groups SG2 and SG3 of the first frame period FP1. Some duplicate descriptions thereof may be omitted. Time points t4e, t5e, and t6e in the second frame period FP2 may correspond to the time points t1e, t2e, and t3e in the first frame period FP1, respectively. For example, time intervals from the time point at which the pulse of the vertical synchronization signal Vsync corresponding to the first frame period FP1 is generated to the time points t1e, t2e, and t3e may be the same as time intervals from the time point at which the pulse of the vertical synchronization signal Vsync corresponding to the second frame period FP2 is generated to the time points t4e, t5e, and t6e.

According to the embodiments of FIGS. 13 and 14, the first sensing signals may be inverted in units of frame periods FP1 and FP2. Accordingly, display distortion caused by the first sensing signals in the first frame period FP1 may be canceled due to display distortion caused by the first sensing signals in the second frame period FP2. Therefore, display quality of the display unit 110 can be improved.

In addition, the second sensing period SRP1 may also have substantially the same configuration and effect as the first sensing period STP1. For example, the number of second sensing signals is p, and p may be an integer greater than 2. The second sensing signals may be divided into q second groups, and q may be an integer less than p and greater than 1. An initial second sensing signal in each of the second groups may be synchronized with the horizontal synchronization signal Hsync.

For example, a third time interval between the initial second sensing signal and a next second sensing signal in one second group may be different from a fourth time interval between a last second sensing signal in one second group and the initial second sensing signal in a next second group.

For example, each of the second sensing signals may correspond to the rising transition or the falling transition, and the second sensing signals in the second frame period FP2 may have transition directions opposite to the corresponding second sensing signals in the first frame period FP1.

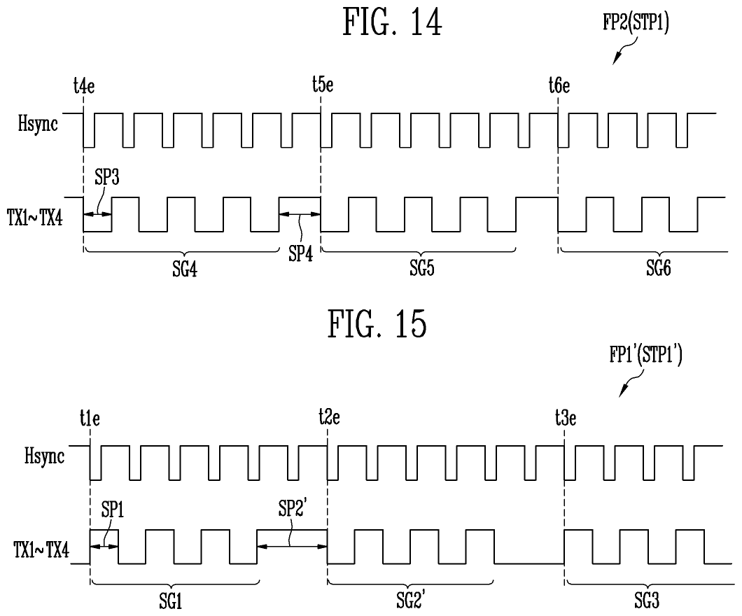

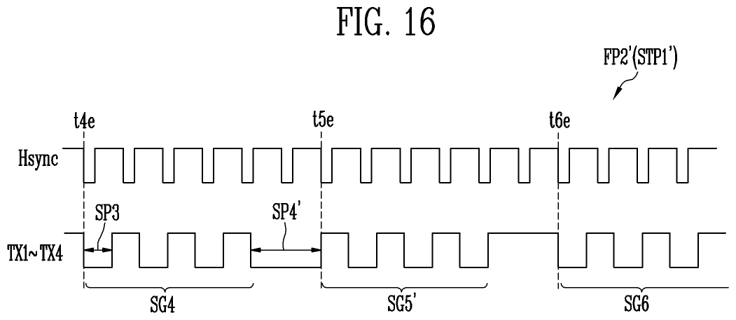

For example, the second sensing signals of the next second group may have the same transition directions as the corresponding second sensing signals of one second group. According to some example embodiments, the second sensing signals of the next second group may have transition directions opposite to the corresponding second sensing signals of one second group (refer to FIG. 15).

According to some example embodiments, the third sensing signals may correspond to the rising transition or the falling transition, and the third sensing signals in the second frame period FP2 may have transition directions opposite to the corresponding third sensing signals in the first frame period FP1.

FIG. 15 is a diagram for explaining a first sensing period of a first frame period according to some example embodiments of the present invention.

In a first sensing period STP1′ of a first frame period FP1′ shown in FIG. 15, first sensing signals of a next first group SG2′ may have transition directions opposite to the corresponding first sensing signals of one first group SG1.

For example, seven first sensing signals of one first group SG1 may alternately repeat the rising transition and the falling transition, but the first transition may be the rising transition and the last transition may be the rising transition. On the other hand, the seven first sensing signals of a next first group SG2′ may alternately repeat the falling transition and the rising transition, but the first transition may be the falling transition and the last transition may be the falling transition.

According to the embodiment of FIG. 15, because inversion occurs in units of groups, display distortion caused by the first sensing signals of the previous first group SG1 may be canceled due to display distortion caused by the first sensing signals of the next first group SG2′. Therefore, the display quality of the display unit 110 can be improved.

The first time interval SP1 between the initial first sensing signal (the rising transition) and the next first sensing signal (the falling transition) in one first group SG1 may be different from a second time interval SP2′ between the last first sensing signal (the rising transition) in one first group SG1 and an initial first sensing signal (the falling transition) in the next first group SG2′.

Because other descriptions of the embodiment of FIG. 15 are duplicated with the descriptions of the embodiment of FIG. 13, some duplicate descriptions may be omitted.

FIG. 16 is a diagram for explaining a first sensing period of a second frame period according to some example embodiments of the present invention.

The first sensing signals in a second frame period FP2′ may be inverted signals of the corresponding first sensing signals in the first frame period FP1′. For example, the first sensing signals in the second frame period FP2′ may have transition directions opposite to the corresponding first sensing signals in the first frame period FP1′.

According to the embodiments of FIGS. 15 and 16, the first sensing signals may be inverted in units of frame periods FP1′ and FP2′ and in units of groups SG1, SG2′, SG3, SG4, SG5′, and SG6. Accordingly, display distortion caused by the first sensing signals in the first frame period FP1′ may be canceled due to display distortion caused by the first sensing signals in the second frame period FP2′. Therefore, the display quality of the display unit 110 can be improved. In addition, as described above, display distortion caused by the first sensing signals of the previous first group SG4 may be canceled due to display distortion caused by the first sensing signals of a next first group SG5′. Therefore, the display quality of the display unit 110 can be improved.

Because other descriptions of the embodiment of FIG. 16 are duplicated with the descriptions of the embodiment of FIG. 14, some duplicate descriptions may be omitted.

The display device and the driving method thereof according to the present invention can accurately calculate the touch position of the user, as distinguished from unintentional touch inputs from external objects such as water droplets or other objects, and can prevent or reduce instances of display distortion of the display unit.

The drawings referred to heretofore and the detailed description of the invention described above are merely illustrative of the invention. It is to be understood that the invention has been disclosed for illustrative purposes only and is not intended to limit the meaning or scope of the invention as set forth in the claims. Therefore, those skilled in the art will appreciate that various modifications and equivalent embodiments are possible without departing from the scope of the invention. Accordingly, the true scope of the invention should be determined by the technical idea of the appended claims and their equivalents.

What is claimed is:

1. A display device comprising:
a plurality of pixels connected to respective scan lines;
a scan driver configured to supply scan signals of a turn-on level to the scan lines at a cycle corresponding to a cycle of a horizontal synchronization signal;
a plurality of first sensors and a plurality of second sensors overlapping at least some of the pixels; and
a sensor driver configured to concurrently supply first sensing signals to the first sensors during a first sensing period, to concurrently supply second sensing signals to the second sensors during a second sensing period, and to sequentially supply third sensing signals to the first sensors during a third sensing period,
wherein a number of the first sensing signals is n, where n is an integer greater than 2,
wherein the first sensing signals are divided into m first groups, where m is an integer less than n and greater than 1, and
wherein an initial first sensing signal in each of the first groups is synchronized with the horizontal synchronization signal.

2. The display device of claim 1, wherein each of the first sensing signals corresponds to a rising transition or a falling transition.

3. The display device of claim 2, wherein the horizontal synchronization signal includes a plurality of pulses, and
wherein a time point at which the initial first sensing signal is generated in each of the first groups is the same as a time point at which one pulse of the horizontal synchronization signal is generated.

4. The display device of claim 1, wherein a first time interval between the initial first sensing signal and a next first sensing signal in one first group is different from a second time interval between a last first sensing signal in the one first group and an initial first sensing signal in a next first group.

5. The display device of claim 4, wherein each of a first frame period and a second frame period following the first frame period includes the first sensing period, the second sensing period, and the third sensing period, and
wherein the first sensing signals in the second frame period are inverted signals of corresponding first sensing signals in the first frame period.

6. The display device of claim 5, wherein each of the first sensing signals corresponds to a rising transition or a falling transition, and
wherein the first sensing signals in the second frame period have transition directions opposite to the corresponding first sensing signals in the first frame period.

7. The display device of claim 6, wherein the first sensing signals of the next first group have the same transition directions as corresponding first sensing signals of the one first group.

8. The display device of claim 6, wherein the first sensing signals of the next first group have transition directions opposite to the corresponding first sensing signals of the one first group.

9. The display device of claim 1, wherein a number of the second sensing signals is p, where p is an integer greater than 2,
wherein the second sensing signals are divided into q second groups, where q is an integer less than p and greater than 1, and
wherein an initial second sensing signal in each of the second groups is synchronized with the horizontal synchronization signal.

10. The display device of claim 9, wherein a third time interval between the initial second sensing signal and a next second sensing signal in one second group is different from a fourth time interval between a last second sensing signal in the one second group and an initial second sensing signal in a next second group.

11. The display device of claim 10, wherein each of a first frame period and a second frame period following the first frame period includes the first sensing period, the second sensing period, and the third sensing period,
wherein each of the second sensing signals corresponds to a rising transition or a falling transition, and
wherein the second sensing signals in the second frame period have transition directions opposite to corresponding second sensing signals in the first frame period.

12. The display device of claim 11, wherein the second sensing signals of the next second group have the same transition directions as corresponding second sensing signals of the one second group.

13. The display device of claim 11, wherein the second sensing signals of the next second group have transition directions opposite to the corresponding second sensing signals of the one second group.

14. The display device of claim 9, wherein the third sensing signals are synchronized with the horizontal synchronization signal.

15. The display device of claim 14, wherein each of a first frame period and a second frame period following the first frame period includes the first sensing period, the second sensing period, and the third sensing period,
wherein each of the third sensing signals corresponds to a rising transition or a falling transition, and
wherein the third sensing signals in the second frame period have transition directions opposite to corresponding third sensing signals in the first frame period.

16. A driving method of a display device comprising:
concurrently supplying first sensing signals to first sensors during a first sensing period of a first frame period;
concurrently supplying second sensing signals to second sensors during a second sensing period of the first frame period; and
sequentially supplying third sensing signals to the first sensors during a third sensing period of the first frame period,
wherein a number of the first sensing signals is n, where n is an integer greater than 2,
wherein the first sensing signals are divided into m first groups, where m is an integer less than n and greater than 1, and wherein an initial first sensing signal in each of the first groups is synchronized with a horizontal synchronization signal.

17. The driving method of claim 16, wherein a first time interval between the initial first sensing signal and a next first sensing signal in one first group is different from a second time interval between a last first sensing signal in the one first group and an initial first sensing signal in a next first group.

18. The driving method of claim 17, further comprising:
concurrently supplying the first sensing signals to the first sensors during the first sensing period in a second frame period following the first frame period;
concurrently supplying the second sensing signals to the second sensors during the second sensing period of the second frame period; and
sequentially supplying the third sensing signals to the first sensors during the third sensing period of the second frame period.

19. The driving method of claim 18, wherein each of the first sensing signals corresponds to a rising transition or a falling transition, and
wherein the first sensing signals in the second frame period have transition directions opposite to corresponding first sensing signals in the first frame period.

20. The driving method of claim 19, wherein the first sensing signals of the next first group have transition directions opposite to corresponding first sensing signals of the one first group.
